(19) United States
(12) Patent Application Publication
(10) Pub. No.: US 2013/0069487 A1
(43) Pub. Date: Mar. 21, 2013

(54) ELECTRICAL ENERGY GENERATOR USING PIEZOELECTRIC CRYSTALS

(71) Applicant: MICHAEL HOUSER, Jacksonville, OR (US)

(72) Inventor: MICHAEL HOUSER, Jacksonville, OR (US)

(73) Assignee: Ocean Energy Management Limited

(21) Appl. No.: 13/429,923

(22) Filed: Mar. 26, 2012

Related U.S. Application Data
(60) Provisional application No. 61/468,036, filed on Mar. 27, 2011.

(51) Int. Cl. H02N 2/18

(52) U.S. Cl. CPC H02N 2/18
USPC 310/339

(57) ABSTRACT

An electrical energy generator and a method of generating electrical energy are provided. The electrical energy generator has a rotating drive shaft, a first member connected to the rotating drive shaft and one or more base plates that encircle the first member and rotate relative to the first member. Each base plate has one or more electrical energy generator components and each electrical energy generator component has one or more piezoelectric elements that are excited when the base plates rotate relative to the first member and that generate electrical energy. The electrical energy output of the electrical energy generator is a total of the electrical energy output of the piezoelectric elements on the one or more base plates.

### PRIORITY CLAIMS/RELATED APPLICATIONS

The application claims the benefit under 35 USC 119(e) and 120 to U.S. Provisional Patent Application Ser. No. 61/468,036, filed on Mar. 27, 2011 and entitled “Electrical Energy Generator Using Piezoelectric Crystals”, the entirety of which is incorporated herein by reference.

### FIELD

The disclosure relates generally to an electrical generator system and method and in particular to an electrical energy generator using piezoelectric elements.

### BACKGROUND

It is known that piezoelectric crystals can be used to generate a spark. This is typically the element in a grill lighter that generates the spark that is used to light the gas in the grill or the lighter fluid on the charcoal of a barbeque. It is also known that one can use piezoelectric crystals to capture energy from the movement of the ocean wherein the movement of the ocean causes the crystals to generate electrical energy. It is also known that piezoelectric crystals can be used in downhole drill applications to provide electrical power to downhole sensors and devices wherein the vibrations of the drill column excites the piezoelectric crystals to generate electrical energy. Thus, it is well known that piezoelectric crystals can be used to generate sparks and electrical energy.

However, to date, no one has created an electrical energy generator that generate energy based on the rotational movement actuating piezo electric elements. Thus, it is desirable to provide such as an electrical energy generator and it is to this end that the disclosure is directed.

### BRIEF DESCRIPTION OF THE DRAWINGS

FIG. 1 illustrates an example of an electrical energy generator;

FIG. 2 is a top view of an electrical energy generating element of the electrical energy generator;

FIG. 3 is a side view of an electrical energy generating element of the electrical energy generator; and

FIG. 4 is a flowchart of a method for generating electrical energy using the electrical energy generator.

### DETAILED DESCRIPTION OF ONE OR MORE EMBODIMENTS

The disclosure is particularly applicable to an electrical energy generating system using the piezoelectric elements shown and described below and it is in this context that the disclosure will be described. It will be appreciated, however, that the electrical energy generating system in accordance with the disclosure has greater utility since it can be used with other types of piezoelectric elements, can be used as a stand-alone electrical energy generator, can be used in conjunction with other apparatus, such as a wave generator, wind power, fuel motor, water head (river, dam), etc to provide the external power. Furthermore, the electrical energy generator may be used in various other applications and with other external power means in which it is desirable to have an electrical energy device.

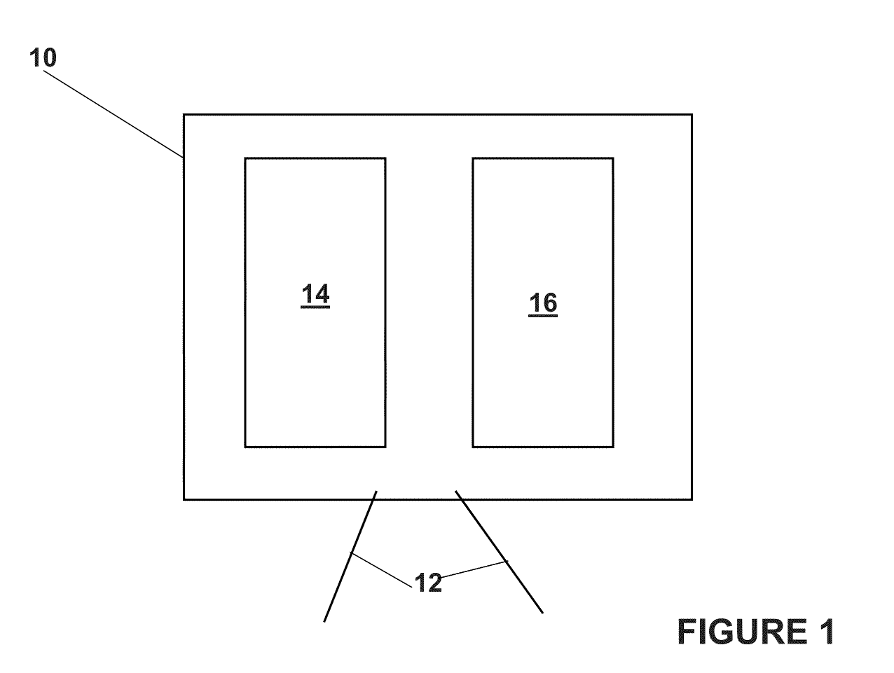

FIG. 1 illustrates an example of an electrical energy generator 10 that can be used to generate electrical power that is produced and output over output ports/leads 12. The electrical energy generator 10 has an electrical energy generating element 14 and a power source 16 to produce the rotational motion of the electrical energy generator (which is inside of the portable electrical energy generator shown in FIG. 1. The power source 16 may be, for example, a wave generator (such as, for example the ocean energy system one disclosed in U.S. patent application Ser. No. 11/942,600 filed on Nov. 19, 2007 and entitled “Ocean Energy System and Method which is incorporated herein by reference), wind power, fuel motor, water head (river, dam), solar power, etc or other known and/or yet to be developed external power sources. Furthermore, the electrical power generator may be a stand-alone device or it may be integrated into larger energy generators and/or larger systems and structures.

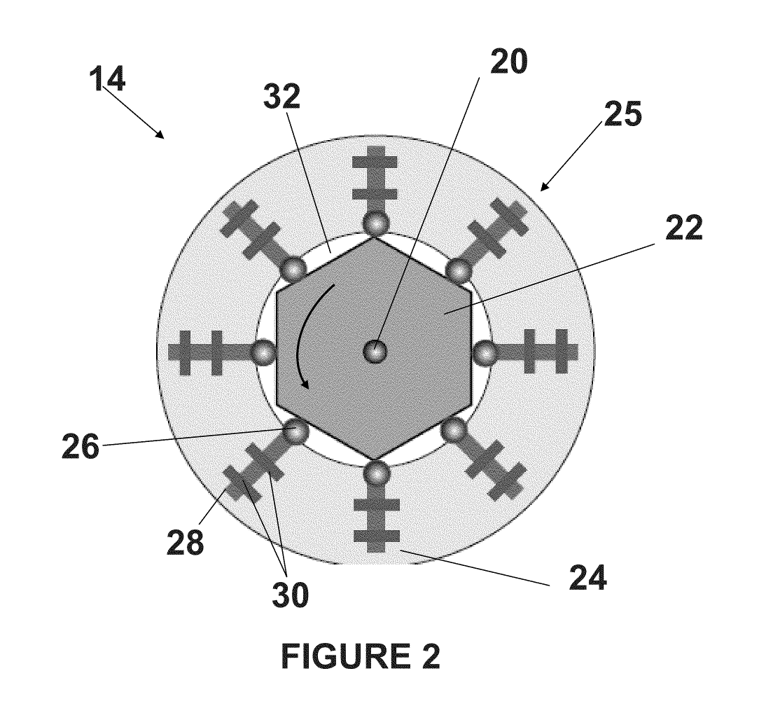

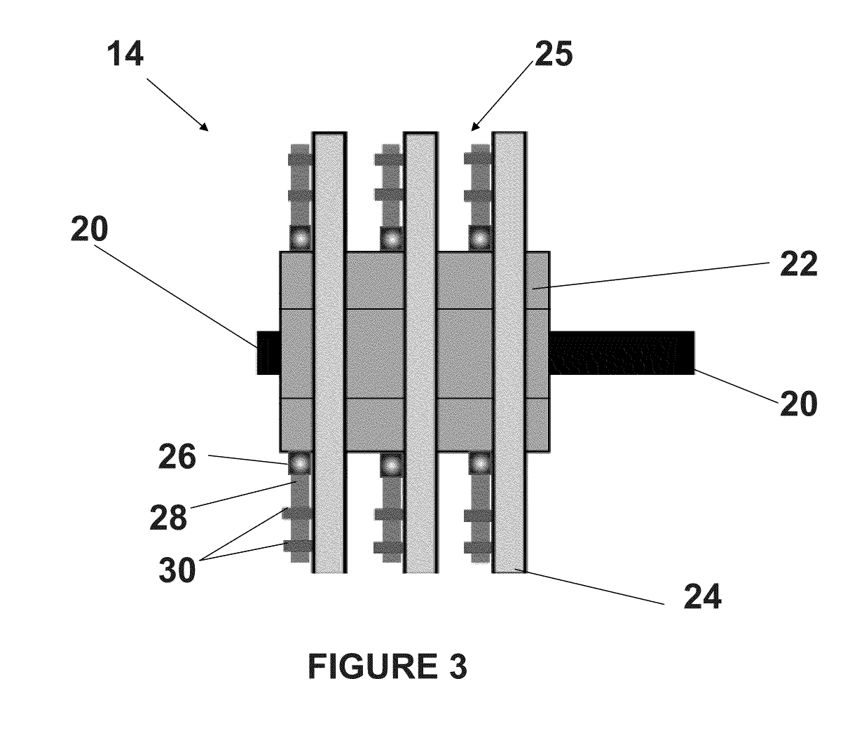

FIG. 2 is a top view of an electrical energy generating element 14 of the electrical energy generator and FIG. 3 is a side view of an electrical energy generating element 14 of the electrical energy generator. The electrical energy generating element 14 may rotate about an axis such as about a drive shaft 20. An element 22, such as a multi-lobe cam member, may be secured to the drive shaft so that the element 22 rotates as the drive shaft rotates. The electrical energy generating element 14 may also have a second member 24 that does not rotate and may be, for example, fixed to an outer wall of the electrical energy generator so that the element 22 rotates relative to the second member 24. The electrical energy generating element 14 may also have one or more electrical energy generator components 25 wherein each electrical energy generator components 25 generates electrical energy. Each electrical energy generator components 25 may further comprise a roller/lifter element 26 that is attached to a piezoelectric element 28 that is retained by one or more retainer elements 30. The one or more retainer elements 30 (two are shown in the implementation in FIGS. 2 and 3) may be secured/attached to the second member 24. In different embodiments and implementations of the electrical energy generator, the electrical energy generator may have a different number of electrical energy generator components 25, such as the eight electrical energy generator components 25 shown in FIGS. 2 and 3. In one embodiment, the element 22 may have one or more surfaces 32 such as the six surfaces shown in FIGS. 2 and 3. As shown in FIG. 3, the electrical energy generating element 14, in some embodiments, may have more than one base plate 24 wherein each base plate has one or more electrical energy generator components 25.

Each piezoelectric element 28 may have an actuating element (not shown) and can be manufactured in a multitude of ways and out of various different materials because different materials give off varying electrical power when bent, stretched, compressed, twisted, etc. so that many configurations piezoelectric element can be actuated and engineered and are part of the disclosure. The unifying aspect of any piezoelectric element is that, when it is stressed in some manner, electrical energy is generated. In one implementation, the piezoelectric element can be a quartz crystal that is used to produce a spark when stresses and quickly released from the stress placed on it.

The one or more retainer elements 30 hold the piezoelectric element 28 and its activating mechanism to the second member 24 (that may be referred to as a base plate) and transfers in some manner a ground connection of the piezoelectric element 28 to the base plate 24.

The first element 22 rotates as described above and provides the timing of the electrical energy generator. In particular, the first element 22 spins which means that the surfaces 32 and the corners rotate past each roller/lifter 26. When a flat surface is adjacent a particular roller/lifter 26, the roller/lifter is in a relaxed position. Then, when a corner where the surfaces 32 meet on the first element is adjacent a particular roller/lifter 26, the first element 22 lifts the particular roller/lifter 26 which is turn drives/stresses the piezoelectric element 28 attached to the particular roller/lifter 26 which causes the piezoelectric element 28 attached to the particular roller/lifter 26 to generate a bit of electrical energy (a spark). As an example of the timing aspect of the first element 22, if the electrical energy generating element 14 has 6 lobes that can activate 10 piezoelectric elements mounted on a base plate (1 spark/activation) and the electrical energy generating element 14 has ten base plates being energized at the same time at 1000 RPM of the drive shaft, the electrical energy generating element 14 achieves 60-cycle electrical power mechanically without conditioning.

The drive shaft 20 spins the first element 22 and may be powered by a power source, such as a wave generator, wind power, fuel motor, solar power, water head (river, dam), etc. since the electrical energy generator can be powered by any power/energy source. The base plate 24 mounts the components and bonds all the ground circuits together for all of the piezoelectric elements. Each roller/lifter 26 rides on the second element 24 and provides the low friction lift energy to activate the Piezoelectric element and its mechanism.

The piezoelectric element 28 (that may be a crystal in some embodiments) may be aligned so that each piezoelectric element polarity and wiring are the same which means that the electrical energy generating element 14 and the generator produces DC current. Alternatively, if the polarity of each piezoelectric element 28 is alternated in the electrical energy generating element 14 of the generator, the generator produces AC current.

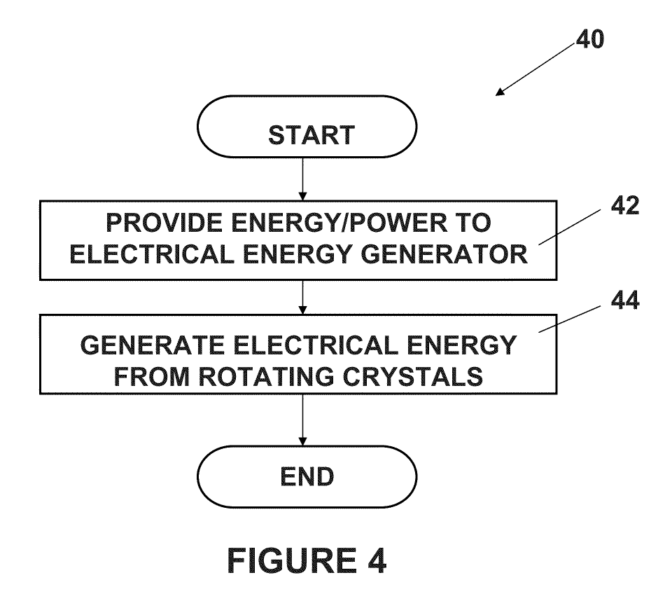

FIG. 4 is a flowchart of a method 40 for generating electrical energy using the electrical energy generator. In the method, energy/power is provided to the electrical energy generator that is used to rotate the drive shaft (42) wherein the energy/power can be provided by various energy/power sources. Once the energy/power is provided to rotate the drive shaft, the drive shaft rotates which causes the one or more electrical energy generating element(s) 14 of the generator to generate electrical energy as described above (44).

While the foregoing has been with reference to a particular embodiment of the invention, it will be appreciated by those skilled in the art that changes in this embodiment may be made without departing from the principles and spirit of the disclosure, the scope of which is defined by the appended claims.

1. An electrical energy generator, comprising:
a rotating drive shaft;
a first member connected to the rotating drive shaft; and
one or more base plates that encircle the first member and rotate relative to the first member, each base plate further comprising one or more electrical energy generator components wherein each electrical energy generator component has one or more piezoelectric elements that are excited when the base plates rotate relative to the first member and that generate electrical energy; and
wherein an electrical energy output of the electrical energy generator comprises a total of the electrical energy output of the piezoelectric elements on the one or more base plates.

2. The generator of claim 1, wherein each electrical energy generator component further comprises a roller element connected to the piezoelectric element and one or more retainer members that retain the piezoelectric element and wherein the roller element periodically excites the piezoelectric element.

3. The generator of claim 2, wherein the first member is a cam member on which each roller element rests wherein the cam moves the roller element that excites the piezoelectric element.

4. The generator of claim 1 further comprising a plurality of piezoelectric elements wherein each piezoelectric element has a polarity that is aligned with the polarity of the other piezoelectric elements so that the electrical energy generator generates a direct current.

5. The generator of claim 1 further comprising a plurality of piezoelectric elements wherein each piezoelectric element has a polarity that is alternated in direction with an adjacent piezoelectric element so that the electrical energy generator generates an alternative current.

6. The generator of claim 1, wherein each piezoelectric element is a piezoelectric crystal.

7. The generator of claim 1 further comprising a power source that provides power to rotate the drive shaft.

8. The generator of claim 7, wherein the power source further comprises one of an ocean energy source, a wind power source, a fuel motor, solar power and a water head.

9. A method for generating electrical energy, comprising:
providing a drive shaft and a first member;
rotating one or more base plates relative to the first member wherein each base plate further comprising one or more electrical energy generator components wherein each electrical energy generator component has one or more piezoelectric elements;
exciting the one or more piezoelectric elements when the base plates rotate relative to the first member; and
generating electrical energy due to the excitation of the one or more piezoelectric elements.

10. The method of claim 9, wherein exciting the one or more piezoelectric elements further comprises providing a roller element on each electrical energy generator component that excites the piezoelectric elements and moving each roller element along the first member that acts as a cam and excites the piezoelectric element.

11. The method of claim 9, wherein generating electrical energy further comprises generating direct current by aligning a polarity of piezoelectric elements.

12. The method of claim 9, wherein generating electrical energy further comprises generating alternating current by alternating the polarities of the piezoelectric elements.
